(19) United States
(12) Patent Application Publication
(10) Pub. No.: US 2007/0197285 A1
(43) Pub. Date: Aug. 23, 2007

(54) Image processing program, recording medium and apparatus

(76) Inventor: Ari Kamijo, Tokyo (JP)

Correspondence Address: DUANE MORRIS, LLP;IP DEPARTMENT, 30 SOUTH 17TH STREET, PHILADELPHIA, PA, 19103-4196, US

(21) Appl. No.: 10/590,869

(22) PCT Filed: Jul. 12, 2005
(86) PCT No.: PCT/JP05/12820

§ 371 Date: Aug. 28, 2006

(30) Foreign Application Priority Data
Jul. 13, 2004 (JP) 2004-232815

(51) Int. Cl. A63F 13/00

(52) U.S. Cl. 463/31; 463/9

(57) ABSTRACT

Technical Problems In a conventional race game to compete in time or order using names of existing places and executed in a computer such as a home video game machine, the background image thereof is an image of a virtual three-dimensional space using a polygon model, which has a difference when compared with a live-action background image of an existing place and therefore lacks reality and a feeling of presence. Also, it lacks speediness and punch as compared with an image from a camera mounted on a racing car in a race program of television. Means for Solving the Problems Live-action videos taken at a real existing place needed from the start to the end of a game are prepared as a moving picture file. By controlling a reproduction speed of the moving picture file based on an image taking direction component speed of a player car operated by a game player and an image taking speed when taken, reality and a feeling of presence are improved, and by combining plural images immediately before a display image from the moving picture file, speediness and punch are improved.

### TECHNICAL FIELD

The present invention relates to an image processing technique for displaying an actual video of a real existing place upon a moving picture background image in an image processing program to be executed on a computer, a recording medium and an apparatus thereof.

### BACKGROUND ART

In a conventional race game or the like executed on a computer and using names of real existing places to compete in time or order of passing through a predetermined route which starts at a certain point and ends at another point or starts at a certain point and returns to the same point, a method of displaying a virtual three-dimensional space image by a polygon model is widely used for a background image thereof.

Here, the virtual three-dimensional space image is an image in which a visual point (virtual visual point) is set to a certain position in a three dimensional space having information in which image displaying elements are specified by coordinates in a three-dimensional coordinated space to show a scene viewing inside the space from that visual point, so as to give a feeling as if an operator is moving in the three-dimensional space by sequentially moving the visual point according to movement of an operated object that is operated by the operator, and is generally referred to as 3D (three dimensional) computer graphics.

### DISCLOSURE OF THE INVENTION

### Problems to be Solved by the Invention

However, in the above technique, due to the virtual three-dimensional space image, there is a difference when it is compared with a live-action background video of an existing place. Consequently, a race game or the like using names of existing places lacks reality and a feeling of presence. Also, by using a live-action video as a background image and merely reproducing a taken video with its reproduction speed being changed (refer to Patent document 1 and Patent document 2), the operated object does not move in a forward or a backward direction but moves in a vertical direction with respect to an image taking direction on a display screen that is seen from the operator, which give a feeling of incompatibility in operation to the operator. This impairs, particularly in a race game or the like, the amusement of the game. Further, it cannot realize a visual point from an operated object superimposed on a background image (hereinafter, referred to as “driver visual point”) and a visual point from a camera mounted on the operated object (hereinafter, referred to as “on-vehicle camera visual point”), which are essential to a race game.

[Patent document 1] Japanese Patent Application Laid-open No. Hei 9-147143 Official Gazette

[Patent document 2] Japanese Patent Application Laid-open No. Hei 9-220308 Official Gazette

Also, in a race program or the like of a television broadcast, when an image from a camera mounted on a racing car is compared with an image displayed in a virtual three-dimensional space image, the actual camera video is in a state that, considering an image taking principle using a camera, a display image at a certain point includes information from a point where the previous image of the display image is taken to a point where the display image is taken. However, in a method of displaying a virtual space image, speediness is expressed by a processing method using elements of a display image (refer to Patent document 3) or a processing method of gradating the screen or combining images displayed in the past (refer to Patent document 4), which lacks the reality and feeling of presence, as well as punch and speediness as compared with the mounted camera video.

[Patent document 3] Japanese Patent Application Laid-open No. Hei 11-151379 Official Gazette

[Patent document 4] Japanese Patent Application Laid-open No. Hei 11-154242 Official Gazette

Accordingly, an object of the present invention is to provide a background image processing program for displaying an existing actual image, without giving an operator a feeling of incompatibility in operation, on a background image of a race game or the like executed on a computer and using names of existing places to compete in time or order of passing through a predetermined route, in which the reality and a feeling of presence, speediness, and punch are improved like an image from a camera mounted on a racing car in a race program or the like of a television broadcast, a recording medium recording the image processing program, and an image processing apparatus.

### Means for Solving the Problems

In order to solve the above problems, a first invention is an image processing program for executing processing on a computer, characterized by including at least: outputting an operation speed and an operation direction based on operation information of an operated object; calculating a reproduction speed of a live-action moving background image based on an image taking direction component of the operation speed; creating a visual point transformed background image in which a visual point of a background image read out based on the reproduction speed is transformed from a visual point in which a display position of the operated object becomes a predetermined position; and superimposing the operated object on the visual point transformed background image.

By using a moving background image which is taken while moving on an existing predetermined course and using a background image in which a visual point is transformed from a visual point in which a superimposing position of the operated object does not move in accordance with the first invention according to claim 1, the image processing program allows a computer to function as an image display means for displaying an actual image of an existing place on a background image of a race game or the like without giving the operator a feeling of incompatibility in operation.

Further, a second invention is an image processing program for executing processing on a computer according to claim 1, characterized by further including image combination processing for combining background images between next one of a background image read out from the moving background image for previous display and a background image read out for display at this time for outputting as a single background image.

In accordance with the second invention according to claim 2, an image like an image from a camera mounted on a racing car in a race program or the like of a television broadcast can be displayed, so that reality and a feeling of presence as well as punch and speediness can be improved.

A third invention is an image processing program for executing processing on a computer according to claim 1 or claim 2, characterized in which the processings are applied to a race game.

In accordance with the third invention according to claim 3, it is possible to provide a race game in which reality, a feeling of presence as well as punch and speediness are improved more than in a virtual space image by allowing a computer to function as an image display means for displaying an actual image of a real existing place on a background image of a race game passing through a really existing predetermined course to display an image like an image of a camera mounted on a racing car in a race program or the like of a television broadcast. Also, it is possible to provide live-action background images of a visual point from the operated object superimposed on the background image (namely, a driver visual point) and a visual point from a camera mounted on the operated object (namely, an on-vehicle camera visual point) which are essential to a race game.

A fourth invention is a computer-readable recording medium recording the image processing program.

In accordance with the fourth invention according to claim 4, the above-described image processing program can be recorded, and read out and executed by a computer as necessary.

A fifth invention is an image processing apparatus, characterized by including at least: an operation information outputting means for outputting an operation speed and an operation direction based on operation information of an operated object; a reproduction speed calculating means for calculating a reproduction speed of an actual moving background image based on an image taking direction component of the operation speed; a visual point transforming means for creating a visual point transformed background image in which a visual point of a background image read out based on the reproduction speed is transformed from a visual point in which a display position of the operated object becomes a predetermined position; and a superimposing means for superimposing the operated object on the visual point transformed background image.

In accordance with the fifth invention according to claim 5, it is possible to provide an image processing apparatus which displays an actual video of a real existing place on a background image of a race game or the like passing through a real existing predetermined course without giving the operator a feeling of incompatibility in operation.

### EFFECTS OF THE INVENTION

In accordance with the first invention, the second invention, and the third invention, reality and a feeling of presence as well as punch and speediness can be improved by displaying an actual video of an existing place on a background image of a race game passing through an existing predetermined course and displaying an image like a video of a camera mounted on a racing car in a race program or the like of a television broadcast without giving the operator a feeling of incompatibility in operation, so that a race game with improved amusement can be provided. Also, display images of a driver visual point and an on-vehicle camera visual point which are essential to a race game can be provided. In accordance with the fourth invention, the image processing program can be recorded. Furthermore, in accordance with the fifth invention, it is possible to provide an image processing apparatus in which reality and a feeling of presence are improved by displaying an actual video of a real existing place on a background image of a race game or the like passing through a really existing predetermined course without giving the operator a feeling of incompatibility in operation.

Here, “displaying without giving the feeling of incompatibility in operation” means to express forward/backward and leftward/rightward movements (a movement of background two moving pictures' taking direction components and a movement of a vertical direction component thereof) of the operated object by means of a relative movement of a background image by not moving the display position of the operated object.

### BEST MODE FOR CARRYING OUT THE INVENTION

Hereinafter, an embodiment of the present invention will be described in detail based on the drawings.

This embodiment relates to a driving game which displays an image with a layout in which a player car as an operated object is superimposed on a display image at approximately the center thereof with a predetermined visual point of looking down from behind as shown in FIG. 8, and it is assumed that a circuit course as shown in FIG. 2 really exists. This game is a driving game, which displays an actual video of the circuit course shown in FIG. 2 on a background, to operate the player car and compete in time of starting from a stopped state, going round the circuit and returning to a point where it started (a start/goal point 301).

Further, in this embodiment, a moving picture image file includes a range where the player car can pass through during a game within the racing course shown in FIG. 2, in which images taken of one round from a starting point (start/goal point 301 in FIG. 2) during a game taken while moving at a constant speed are compressed by a method complying with the MPEG (Moving Picture Experts Group) and recorded in a recording medium 2. This file structure is shown in FIG. 3. However, images of respective points in FIG. 3 are ones before being compressed and include coordinate data, respective image taking position data, and image taking direction data which are divided in necessary regions for visual point transforming processing, which will be described later.

FIG. 4 is a configuration block diagram showing an embodiment of a computer apparatus to which the image processing apparatus of the present invention is applied. This apparatus is constituted of a main body 1, a recording medium 2 in which image processing program data and the moving picture image file are stored, an input device 3 which inputs game operation information of a player, a speaker 4 which outputs sound during a game, and a computer display 5 which displays a game screen. As the above-described recording medium 2, for example, a CDRW 2a, a floppy® disk 2b, and an MD (mini disk) 2c shown in FIG. 9, a memory stick 2d, an external or internal hard disk (not shown) or the like can be used. The image processing program recorded in the recording mediums 2 (2a to 2d) can be read into a computer and executed as necessary.

Inside the main body 1, it has a CPU (central processing unit) 100 and a bus line 101 constituted of an address bus, a data bus, and a control bus connected to the CPU 100. To the bus line 101, a data RAM (main memory) 102, an input interface 103, an ROM 104, a recording medium decoder 105, a drawing processor (graphics processor) 108, an expansion circuit 110, a sound processor 111, and an amplifier 113 are connected.

This computer apparatus can vary in its form depending on an application. For example, when this computer apparatus is an arcade game machine, all the components of FIG. 1 are accommodated in a single case, and in the case of a driving game for example, the input device is a steering wheel, a brake, an accelerator, or the like, while in the case of a home video game machine having a CPU, it is connected to a TV monitor instead of the display 5 and the speaker 4, and the input device is a game controller or the like.

Next, the respective components will be explained. First, the data RAM 102 stores a game program main body, expanded data of the moving picture file (movie file), other necessary data for the game, a work area, and so on.

The input interface 103 performs processing of acquiring operation information of a game player from the input device and making it in the form which can be processed by the CPU 100.

The ROM 104 corresponds to a BIOS (Basic Input Output System) in a personal computer and stores a program for controlling start-up processing of the computer apparatus and reading and executing of a program which is recorded in the recording medium 2 and to be executed first, a driver program for a basic input output device, and so on.

A recording medium driver 107 reads out data into a buffer 106 from, for example, a CD-ROM, a DVD-ROM, a hard disk drive, or the like as a recording medium, performs error compensation and correction processing by means of ECC (Error Correction Code) in the recording medium decoder 105, and thereafter sends the read data to the data RAM 102 or the like according to instruction of the CPU.

The drawing processor 108 is for creating signals which enable monitor to display contents of a drawing buffer 109 as an image based on instruction of the CPU 100.

The expansion circuit 110 performs processing of expanding a compressed image complying with the MPEG for a moving picture or the JPEG (Joint Picture Experts Group) for a still image. In this embodiment, it performs processing of expanding data read out from the moving picture image file for using an actual image of a real existing place as the background of the race game.

The sound processor 111 directly or temporarily stores in a buffer 112 sound data recorded in the storage medium based on instruction of the CPU 100, and generates predetermined music or sound which are processed (subjected to sound effect) as necessary. Generated sound is amplified by the amplifier 113 and outputted from the connected speaker 4.

FIG. 5 is a program flowchart showing a procedure of displaying an actual image of a real existing place from the moving picture image file on the background image of the race game in the embodiment of the present invention without a feeling of incompatibility in operation.

First, when game processing is started, initialization data which are necessary during the game, such as image data of the player car, are read from the recording medium 2 into part of the data RAM 102 (Step S1), and thereafter the moving picture image file is started to be transferred from the recording medium 2 to a region secured as a file reading buffer in part of the data RAM 102 (Step S2).

Next, it is judged whether the amount of read data has reached a designated amount below the amount secured as the reading buffer (Step S3). Here, immediately after the read amount has reached the designated amount, the actual game starts (Step S4). Here, “the game starts” means that a game player as an operator becomes able to start operation of the player car as the operated object.

When the game is started, time measurement is started. Background images up to a current point (a start point immediately after the game is started) of the player car operated by the player are expanded by the expansion circuit 110. Here, how far a superimposing position of the player car is from the center line in a image taking direction of the background image in the vertical direction of the image taking direction is calculated, and the background image is subjected to visual point transformation processing (Step S5) so that the player car is at the center of the display image and a display direction of the player car becomes the same as that of the last time. Specifically, processing of Step S5 performed by the CPU 100 is processing for creating a visual point transformed image in which a visual point is transformed to a visual point in which a display position of the operated object becomes a predetermined position. Here, while the expansion circuit 110 is performing the expansion processing, if the expanded image is subjected to the visual point transformation processing simultaneously by the CPU 100 and so on, the speed of the processing can be increased.

Here, a visual point transformation technique “a combining technique of a two-dimensional video and three-dimensional computer graphics capable of moving a visual point, technique classification A-10—combining with an actual image, Patent Office standard technique collection” is used. For example, when the superimposing position of the player car is on the right side of the center as shown in FIG. 1 in a background image before being subjected to the visual point transformation processing (refer to FIG. 1), the player car is displayed on the center of the display image as shown in FIG. 8 by the visual point transformation processing. Next, background image data which are expanded and subjected to the visual point transformation are transferred to the drawing buffer 109. Specifically, the player car shown in FIG. 1 before the visual point transformation is positioned slightly rightward in the horizontal direction of the screen, whereas the player car shown in FIG. 8 after the visual point transformation is positioned at substantially the center in the horizontal direction of the screen.

This “combining technique of a two-dimensional image and three-dimensional computer graphics capable of moving a visual point, technique classification A-10—combining with a live-action, Patent Office standard technique collection” is an image combining technique capable of moving a visual point by modifying an image to be seen from another camera angle. In order to obtain a naturally combined image of CG and a live-action, the position, direction, and image angle of a camera for taking the actual image need to correspond with a camera angle for creating the CG video. Thus, it is a technique such that by modifying a live-action video from a fixed camera according to a camera angle of the CG rather than corresponding the camera angle of the live-action to the CG, they can be combined easily, and in this technique, the system divides an image into regions such as left and right sides, a front side wall, a ceiling, a floor, and so on from information set for the image and several assumptions, and presumes automatically a three-dimensional shape model of the original image by obtaining respective three-dimensional coordinates thereof. It is a technique such that based on this three dimensional shape, a two-dimensional image is modified so as to correspond with the camera angle of the computer graphics, thereby naturally combining the live-action and the computer graphics. (Reference: “Interactive Image Re-combining for Expressing Arbitral Visual Point Movement,” “Information Processing Society Study Report, Graphics and CAD 81-11” (Aug. 23, 1996), written by Yoichi Horii and Kiyoshi Arai, published by Information Processing Society)

Returning to the description of FIG. 5, it is further explained. Here, when the combining processing according to the above-described claim 2 is performed, next one of a previously displayed background image to a background image to be displayed this time are combined (Step S6). Specifically, this processing is an image combination processing for outputting background images between next one of a background image read out for previous display and a background image read out for display at this time as a single background image. In this embodiment, images to be combined are transferred to the drawing buffer 109, and the combining process is performed by the drawing processor 108 by instruction of the CPU 100.

For example, when the player car is running at a P point 302 shown in FIG. 2 in the same direction as an image taking direction (FIG. 2, the arrow direction at the P point 302) at a speed that is three times an image taking speed, an image of a current position and a first and a second previous image from the current position are combined as a background image to be displayed. Specifically, according to reproduction speed calculation processing which will be described later, a third previous image from the current position is already displayed and thus not to be combined. Here, these three images are combined respectively by an alpha blending method by 33.3%.

By instruction of the CPU 100, the drawing processor 108 displays a combined image of image data of the player car read out in advance and background image data (Step S7). Specifically, processing of Step S7 performed by the drawing processor 108 by instruction of the CPU 100 is superimposing of the operated object on the visual point transformed background image. At this time, reality and a feeling of presence can be further increased by measuring a light source at the time of taking the moving picture file and performing processing to irradiate the player car with the same light source, processing to make a shadow of the player car, or the like.

Next, the CPU 100 obtains player operation information from the input interface 103 (Step S8), and calculates the direction and the speed of the player car (Step S9). Then, it is calculated how many multiples of the image taking speed of the moving picture image file there are in a display image taking direction component of the player car speed (this number of the multiples is referred to as M) (Step S10). Then, with N being the integer portion of a value after being added the fractional portion of a previously calculated M, it is determined that the background image to be displayed next time is the N-th image from the currently displayed image (Step S11). Specifically, the processing from Step S10 to Step S11 performed by the CPU 100 is to calculate a reproduction speed of a moving picture background image based on an image taking direction component of an operation speed of the operated object.

Here, Steps S8 to Step S11 are described in detail with an example that a player object is running a P point 302 in FIG. 2. The currently displayed image is an image 402 in which includes the P point 302 in FIG. 2, and an image taking speed at the time of taking this image is referred to as V9 (501 of FIG. 6). The arrow direction of 501 of FIG. 6 is the same as the arrow direction of the P point 302 of FIG. 2.

First, the player operation information in Step S8 are, for example, information showing how much the player is applying or pressing the brake or the accelerator, and information showing which side and how much the player is turning the steering wheel. In Step S9, an acceleration effect due to pressing of the accelerator, a deceleration effect due to applying of the brake, and a running resistance effect such as air resistance are calculated using various types of parameters of the player car (a weight, engine characteristics, a wheel base, a gravity center position, and so on) and various types of parameters of other than the player car (a wind direction, a wind force, a friction coefficient between a road surface and a tire, an inclination of a road surface, and so on at this point), and using the results thereof, a direction and a speed of the player car for determining a background image to be displayed next time are calculated. It is assumed that calculation results are: the direction of the player car is the direction 503 in FIG. 6, and the speed thereof is V1.

Next, in Step S10, the value M indicating how many multiples of the image taking speed of the moving picture image file there are in the display image taking direction component of the player car speed is calculated as follows, with the angle difference 502 of FIG. 6 being K.
M=V1×cos K/V9+L
where L is the fractional part of the M value that is calculated last time, and the value of L is changed after this calculation and used in reproduction speed calculation processing next time for calculating how many multiples of an image taking speed there are in the speed of the player car. Also, “V1×cos K” is nothing more or less than the image taking direction component of the operated object operation speed.

Then, in Step S11, with N being the integer portion of M, it is determined that a background image to be displayed next time is the N-th image from the currently displayed image. Specifically, it is equivalent to that the reproduction speed of the moving picture image file at this time has become N times faster.

Here, the reproduction speed calculation processing of the moving picture image file performed by the CPU 100 will be explained with a specific example. Now, if the value of V1 is 3.4, K is 0.0, V9 is 1.0, and the value of L is 0.2, the value of M is 3.6. Thus, the integer portion N of M is 3, and then the background image to be displayed next time is the third image from the currently displayed image. Here, the number of L is changed to 0.6. If values of V1, K, and V9 are not changed in calculation to determine the next display image, the value of M is 4.0. Thus, the integer portion N of M is 4, and then the background image to be displayed next time is the fourth image from the currently displayed image and the value of L is changed to 0.0.

When this calculation to determine the reproduction speed is performed several ten times in one second for example by the reproduction speed calculation processing as above and the background is drawn the same number of times, the background image can move substantially faithfully to the speed of the player car when seen from the game player.

Returning to the description of FIG. 5, it is further explained. In Step S12, the reading buffer for the moving picture image file is emptied by the data amount up to a previous one of the current position background image (which are finished using) existing in the buffer, and when available capacity of the buffer becomes a predetermined amount or larger, subsequent part of the moving picture image file is read therein (Step S13).

Finally, it is judged whether the player car has completed a round and returned to the start point (start/goal point 301), in other words, whether the game is finished, and when it has not returned to the start point, the process returns to Step S5. When it has returned to the start pint, the round time is saved and the game is finished (Step S14).

### Effect of the Embodiment

According to this embodiment, by displaying an actual image of an existing place on the background image of a race game passing through a predetermined route without giving a feeling of incompatibility in operation to an operator, it becomes a race game in which reality and a feeling of presence are improved, and thus the amusement of the game is improved. Also, by combining and displaying from the next one of a previously displayed background image to a background image to be displayed this time, it becomes a race game which displays a background image having speediness and punch like an image from a camera mounted on a racing car in a race program or the like for television, which increases the amusement of the game.

### Other Embodiments

In the above embodiment, the speed of image taking for the moving picture image file is a constant value, but by entering image taking speed information in each image of the moving picture image file, a reproduction speed of the moving picture image file can be calculated. In this case, the image taking need not be at a constant speed.

Also, in this embodiment, although no other object than the player car is displayed, it may be a race game in which objects except for the player is combined and displayed, as in the case of a race game in which plural race cars compete in rank order as shown in FIG. 7. As these objects except for the player, an object operated by the CPU, an object operated by another player in the same computer apparatus, an object operated by another player via a network, and the like are conceivable. This FIG. 7 is an image from the visual point of an on-vehicle camera.

In the above embodiment, compressed images in the moving picture file are all expanded, but when processing of the above-described claim 2 is not performed, the time taken in the processing of Step S5 is reduced and the entire game is processed at a high speed by performing image compression of the moving picture file by an image compression method not depending on a previous and a next image. This method is effective in the case where image expansion processing ability of a computer apparatus is low.

According to the above embodiments, it is possible to provide a race game executed on a computer to run through a predetermined route in an existing place and compete in time or rank order, which displays an actual video as a background with reality, a feeling of presence, speediness and punch. Also, the method of taking a background image at a real existing place generally requires lower costs for creating a background image as compared with a polygon model creating method used for a virtual three-dimensional space image.

Furthermore, the techniques of claims 1 to 5 used in this embodiment can be applied to an actual video of a real existing place as a background image for various games such as a race game on snow fields such as ski race, snowboard race, snowmobile race, and the like and a race game on water such as jet ski race, boat race, and the like, which use a real existing place as a course. Moreover, they can be applied to a simulator for driver training.

### BRIEF DESCRIPTION OF DRAWINGS

FIG. 1 shows a game image in an embodiment (before transforming a visual point);

FIG. 2 shows a circuit course layout that is assumed to really exist where a moving picture is taken in the embodiment;

FIG. 3 shows a structure of a moving picture file in the embodiment (images are before being compressed);

FIG. 4 is a configuration block diagram of an embodiment of a computer apparatus in this invention;

FIG. 5 is a flowchart showing a display procedure of background image processing in a race game showing an embodiment of the present invention;

FIG. 6 shows a running direction of a player object that is running at a P point 302 in FIG. 2 and an image taking direction of a background image being displayed including the P point in the moving picture file;

FIG. 7 shows a game image in the race game upon which objects except for a player are combined and displayed (visual point of an on-vehicle camera);

FIG. 8 shows a game image in the embodiment (after transforming a visual point); and

FIG. 9 is a perspective view showing a computer apparatus main body and recording media.

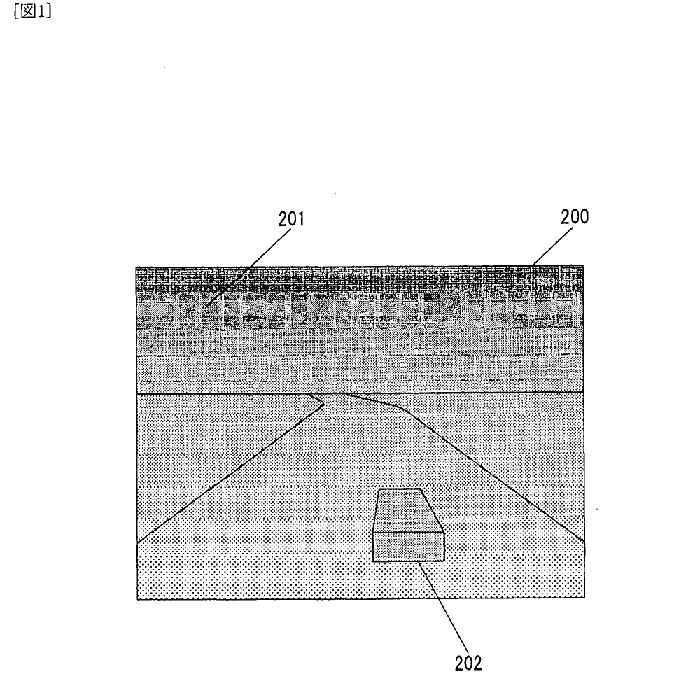

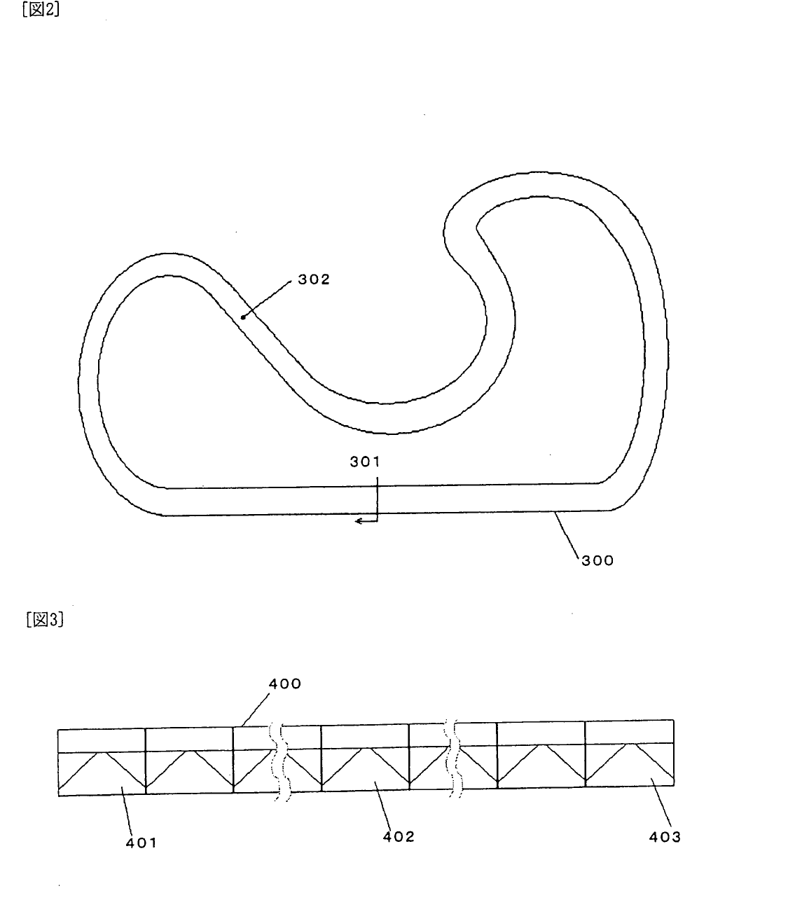

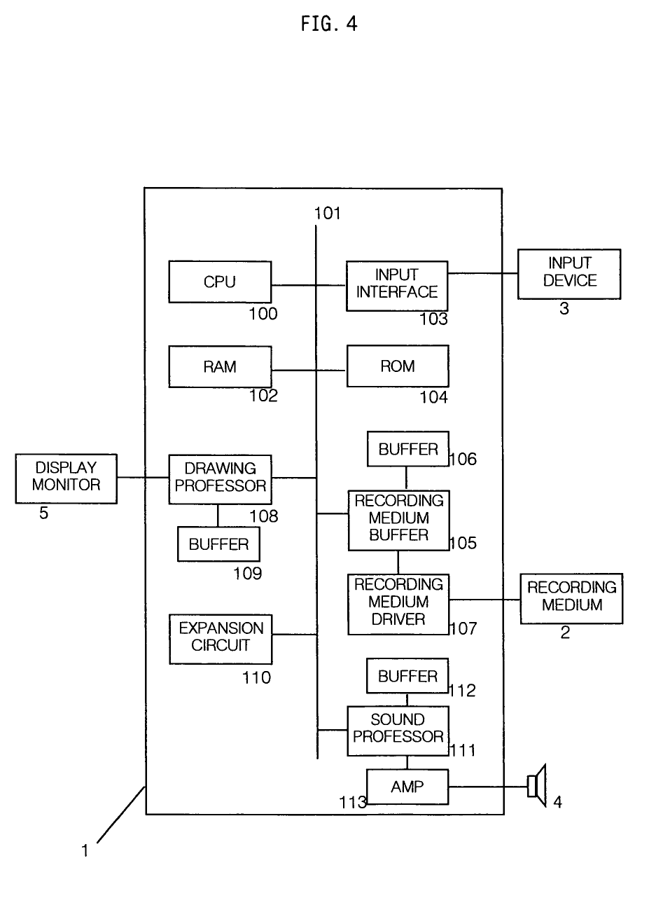

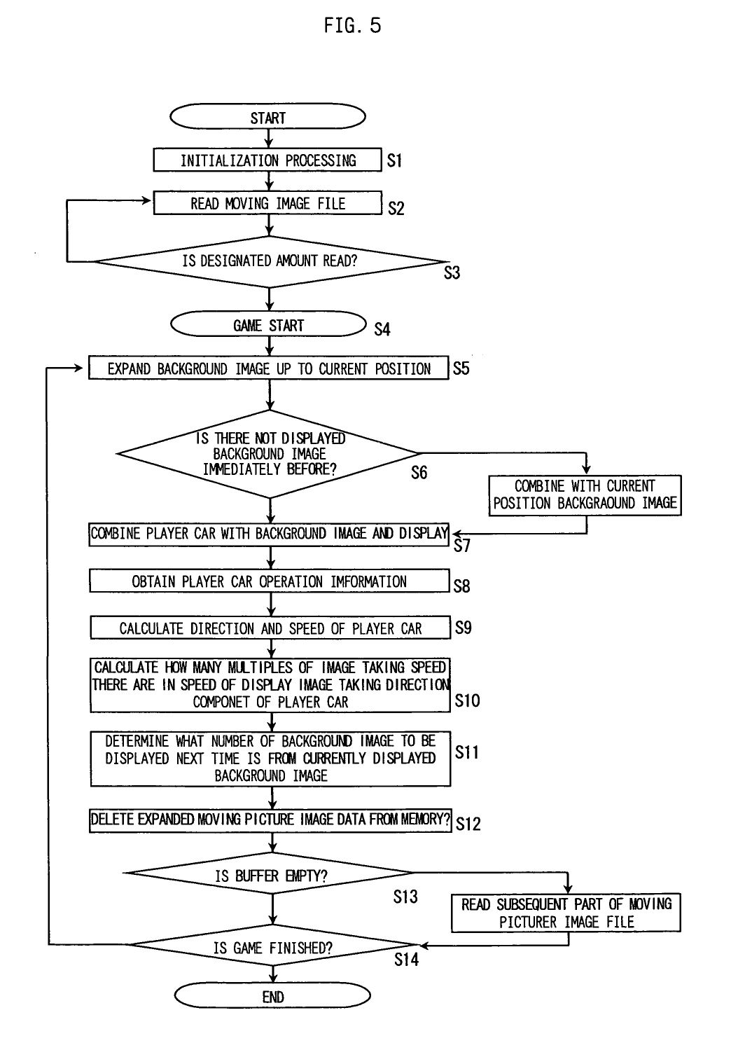

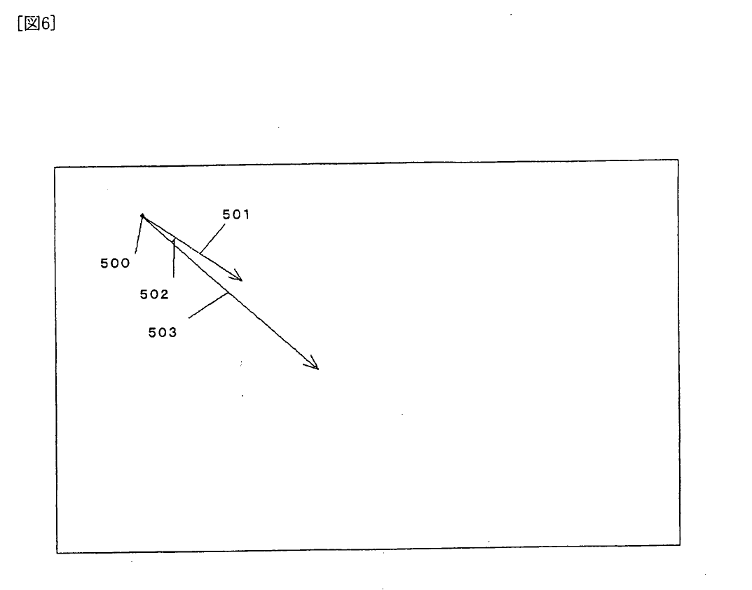

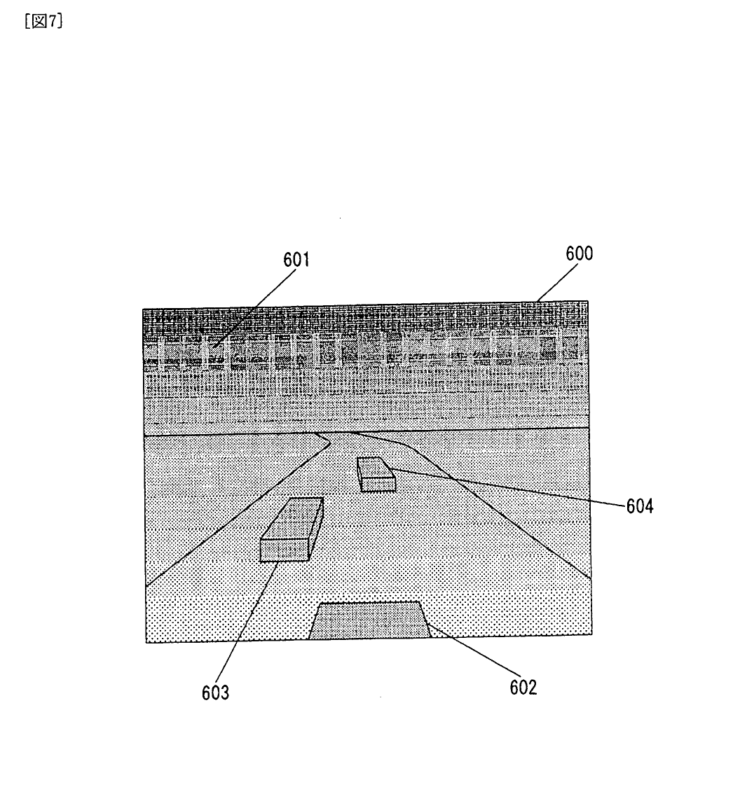

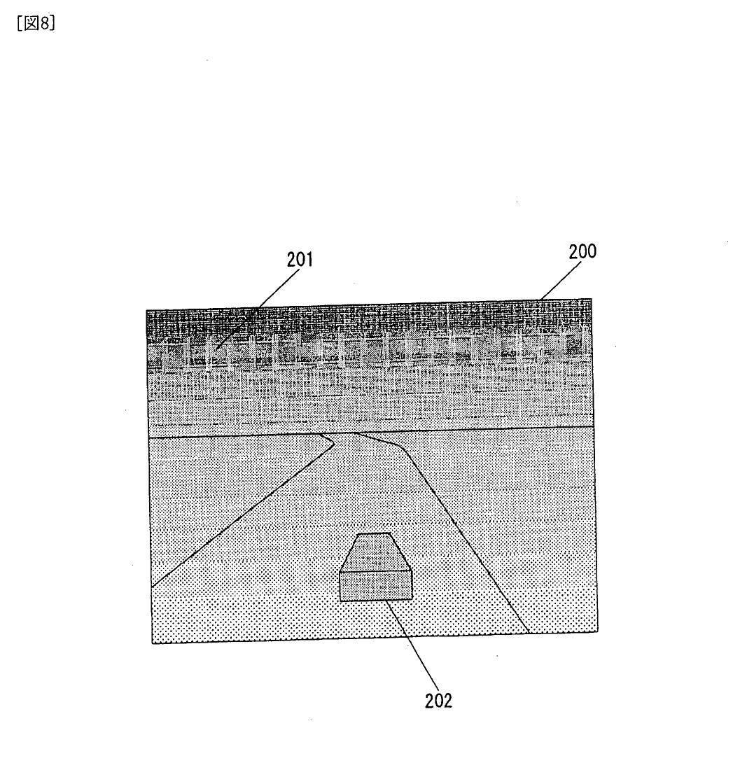

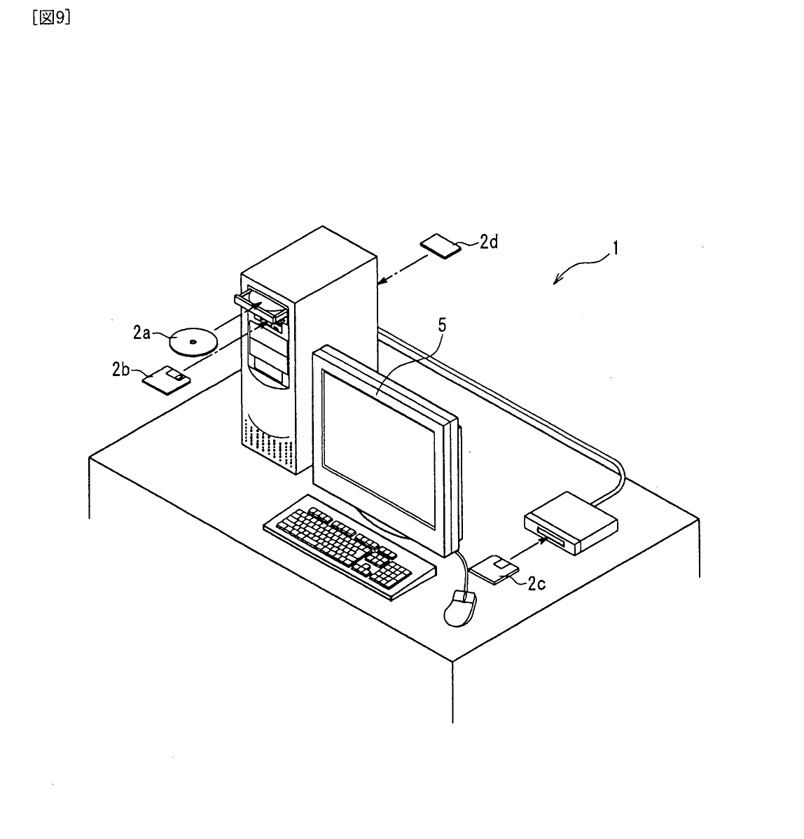

### EXPLANATION OF NUMERALS AND SYMBOLS

1 computer main body
2 recording medium
3 input device
4 speaker
5 display monitor
100 CPU
101 bus line
102 data RAM
103 input interface
104 ROM
105 recording medium decoder
106 recording medium buffer
107 recording medium driver
108 drawing processor
109 drawing buffer
110 expansion circuit
111 sound processor
112 sound buffer
113 amplifier
200 embodiment race game screen
201 circuit course live-action background image
202 player car
300 circuit course
301 start/goal point
302 P point where a player car is running, the arrow being a moving picture taking direction at this point
400 moving picture file overall video
401 image of a start point
402 image including a P point
403 image of a goal point
500 P point 302
501 moving picture image file taking direction
502 angle difference between a moving picture image file taking direction and a player car traveling direction
503 player car traveling direction
600 game screen in a race game on which objects except for a player are superimposed
601 circuit course live-action background image
602 player car
603 object 1 except for a player car
604 object 2 except for a player car

1. An image processing program for executing processing on a computer, comprising at least:
a step outputting an operation speed and an operation direction based on operation information of an operated object;
a step calculating a reproduction speed of an live-action moving background image based on an image taking direction component of the operation speed;
a step creating a visual point transformed background image in which a visual point of a background image read out based on the reproduction speed is transformed from a visual point in which a display position of the operated object becomes a predetermined position; and
a step superimposing the operated object on the visual point transformed background image.

2. The image processing program for executing processing on a computer according to claim 1, further comprising
an image combination step combining background images between next one of a background image read out from the moving background image for previous display and a background image read out for display at this time to output as a single background image.

3. The image processing program for executing processing on a computer according to claim 1 or claim 2,
wherein said steps are applied to a race game.

4. A computer readable recording medium recording the image processing program according to any one of claim 1 to claim 3.

5. An image processing apparatus, comprising at least:
an operation information outputting means for outputting an operation speed and an operation direction based on operation information of an operated object;
a reproduction speed calculating means for calculating a reproduction speed of a live-action moving picture background image based on an image taking direction component of the operation speed;
a visual point transforming means for creating a visual point transformed background image in which a visual point of a background image read out based on the reproduction speed is transformed from a visual point in which a display position of the operated object becomes a predetermined position; and
a superimposing means for superimposing the operated object on the visual point transformed background image.
